(19) United States
(12) Patent Application Publication
(10) Pub. No.: US 2009/0286116 A1
(43) Pub. Date: Nov. 19, 2009

(54) FUEL CELL SYSTEM AND CONTROL METHOD THEREOF

(75) Inventors: Yuji MATSUMOTO, Saitama (JP); Junji UEHARA, Saitama (JP); Kenichiro UEDA, Saitama (JP)

Correspondence Address: LAHIVE & COCKFIELD, LLP;FLOOR 30, SUITE 3000, ONE POST OFFICE SQUARE, BOSTON, MA, 02109, US

(73) Assignee: Honda Motor Co., Ltd., Tokyo (JP)

(21) Appl. No.: 12/465,706

(22) Filed: May 14, 2009

(30) Foreign Application Priority Data
May 19, 2008 (JP) 2008-130666

(51) Int. Cl. H01M 8/04

(52) U.S. Cl. 429/17

(57) ABSTRACT

The present invention provides a fuel cell system and a control method thereof that performs a scavenging process when the fuel cell is stopped, whereby stable electrical power production is ensured after startup, and faster startup is possible. The fuel cell system performs the scavenging process in which scavenging gas is supplied into an anode gas system when the fuel cell is stopped. When a startup request for the fuel cell is detected while the anode scavenging process is being performed, the concentration of hydrogen in the anode gas is detected, and then whether to continue the anode scavenging process and prohibit the fuel cell from starting, or to suspend the anode scavenging process and allow the fuel cell to start is determined based on this detected concentration of hydrogen in the anode gas system.

This application is based on and claims the benefit of priority from Japanese Patent Application No. 2008-130666, filed on 19 May 2008, the content of which is incorporated herein by reference.

### BACKGROUND OF THE INVENTION

1. Field of the Invention

This invention relates to a fuel cell system. More particularly, the present invention relates to a fuel cell system performing a scavenging process for an anode gas system when the fuel cell is stopped.

2. Related Art

In recent years, fuel cell systems have gained the spotlight as a new power source for automotive vehicles. A fuel cell system is provided with, for example, a fuel cell that generates electric power by chemically reacting reactive gases and a reactive gas supply device that supplies the fuel cell with the reactive gases via a reactive gas flow channel.

For example, the fuel cell consists of a plurality, for example, tens or hundreds, of stacked cells. In such an example, each cell is configured with a membrane electrode assembly (MEA) placed between a pair of separators. The MEA is configured with two electrodes, which are an anode (negative electrode) and a cathode (positive electrode), and a solid polymer electrolyte membrane placed between these electrodes.

Supplying hydrogen gas as anode gas and air as cathode gas to the anode electrode and the cathode electrode, respectively, causes an electrochemical reaction by which the fuel cell produces electric power. Basically, since only neutral water is produced when electric power is generated as described above, fuel cell systems have attracted attention from the viewpoint of environmental impact and efficiency in use.

In such a fuel cell system, the water generated during electricity generation remains in the fuel cell and the reactive gas flow channel after electric power generation is stopped. When the fuel cell system is left in an environment in which the outside temperature is below freezing after electric power generation has stopped, the residual water freezes in the fuel cell and the reactive gas flow channel, and it becomes difficult to ensure the stability of electricity generation from the fuel cell when the fuel cell system is started the next time.

Accordingly, during the shutdown of the fuel cell, the scavenging process, which discharges residual water out of the fuel cell system, is performed by circulating scavenging gas inside the fuel cell and the reactive gas flow channel (refer to Japanese Unexamined Patent Application Publication No. 2007-180010, hereinafter referred to as Patent Document 1). Particularly, in the fuel cell system disclosed in Patent Document 1, the fuel cell is prohibited from starting until the scavenging process has completed, i.e. until scavenging from the fuel cell and the reactive gas flow channel has completely finished. In this way, the electricity generation stability of the fuel cell immediately after the fuel cell starts is ensured.

In such a fuel cell system, stable electricity generation after startup can be ensured; however, when a driver turns on the ignition in order to instruct startup of the fuel cell while the scavenging process is being performed, it is necessary to wait for the scavenging process to be completed to actually startup, whereby marketability may suffer.

### SUMMARY OF THE INVENTION

An object of the present invention is to provide a fuel cell system and a control method thereof which performs a scavenging process during shutdown of the fuel cell, whereby it is possible to ensure stable electricity generation after startup and to startup more quickly.

In order to achieve the above-mentioned objective, the present invention provide a fuel cell system (for example, the below-mentioned fuel cell system 1) includes: a fuel cell (for example, the below-mentioned fuel cell 10) that supplies anode gas and cathode gas to an anode and a cathode, respectively, and generates electric power by a chemical reaction of the anode gas with the cathode gas; a scavenging means (for example, the below-mentioned ECU 40 and the below-mentioned scavenging process execution unit 42) for performing a scavenging process in which scavenging gas is supplied into an anode gas system (for example, the below-mentioned anode flow channel 13, the below-mentioned hydrogen supply channel 33, the below-mentioned hydrogen reflux channel 34, the below-mentioned hydrogen discharge channel 35, and the below-mentioned anode scavenging gas discharge channel 36) in which anode gas and anode off gas circulate, when the fuel cell is stopped; a startup request detection means (for example, the below-mentioned ignition switch 41) for detecting a startup request for the fuel cell; a first gas concentration detection means (for example, the below-mentioned ECU 40, the below-mentioned purge process execution unit 43, and a means for performing Step S2 in FIG. 3) for detecting the concentration of anode gas in the anode gas system as a first gas concentration; and a startup-on-scavenging determination means (for example, the below-mentioned ECU 40, the below-mentioned purge process execution unit 43, and a means for performing Steps S3 to S5 in FIG. 3) for determining whether to continue the scavenging process and prohibit the fuel cell from starting, or to suspend the scavenging process and allow the fuel cell to start, based on the detected first gas concentration, when a startup request for the fuel cell is detected while the scavenging process is being performed.

According to the present invention, whether to continue the scavenging process and prohibit the fuel cell from starting, or to suspend the scavenging process and allow the fuel cell to start, is determined based on the first gas concentration detected by the first gas concentration detection means, when a startup request for the fuel cell is detected while the scavenging process of the anode gas system is being performed. In this way, when a startup request is detected while the scavenging process is being performed, the fuel cell may be able to start quickly without waiting until this scavenging process has completed. Here in particular, whether to allow the fuel cell to start or to prohibit the fuel cell from starting is determined in response to the concentration of anode gas in the anode gas system.

Therefore, marketability of the fuel cell system can be improved by ensuring stable electricity generation after startup of the fuel cell, as well as startup more quickly.

In this case, it is preferable for the startup-on-scavenging determination means to determine that the scavenging process is continued and prohibit the fuel cell from starting in a case where the detected first gas concentration is greater than a predetermined first determination concentration.

According to the present invention, the first gas concentration is detected when a startup request for the fuel cell is detected while the scavenging process of the anode gas system is being performed and, in a case where the detected first gas concentration is greater than the first determination concentration, the scavenging process is continued and startup of the fuel cell is prohibited. In this way, the fuel cell is prevented from being allowed to start when the scavenging process is not substantially completed, whereby marketability of the fuel cell system.

In this case, it is preferable that the fuel cell system of the present invention further includes: a dilution means (for example, the below-mentioned diluter 50) for mixing anode off gas with dilution gas that dilutes the anode off gas, and then discharging this mixed gas out of the fuel cell system; a second gas concentration detection means (for example, the below-mentioned ECU 40, the below-mentioned purge process execution unit 43, and a means for performing Step S6 in FIG. 3) for detecting the concentration of anode off gas remaining in the dilution means as a second gas concentration; and a startup purge means (for example, the below-mentioned ECU 40, the below-mentioned purge process execution unit 43, and a means for performing Steps S7 to S10 in FIG. 3) for performing a purge process that replaces gas in the anode gas system with newly supplied anode gas when the fuel cell starts, in which the startup purge means decreases the replacing amount of gas for the purge process as the detected second gas concentration increases, when the purge process is performed after the startup-on-scavenging determination means allows the fuel cell to start.

The concentration of the anode off gas in the dilution means increases temporarily when this purge process is performed. Then, when the concentration of anode off gas exceeds the concentration of anode off gas dilutable by the dilution means, a high concentration of anode off gas may be discharged.

According to the present invention, in a case where the purge process that replaces gas in the anode gas system with newly supplied anode gas is performed after the startup of the fuel cell is allowed, the replacing amount of gas during this purge process decreases as a second gas concentration detected by the second gas concentration detection means increases. In this way, the purge process is performed in accordance with the concentration of anode off gas remaining in the dilution means, whereby the time for this purge process can be shortened. Therefore, the fuel cell can start quickly, which can improve the marketability of the fuel cell system.

In this case, it is preferable for the startup purge means to maintain the replacing amount of gas for the purge process despite the detected second gas concentration in a case where the detected second gas concentration is not greater than a predetermined second determination concentration.

According to the present invention, when the purge process is performed after the fuel cell is allowed to start, the second gas concentration is detected and, in a case where this second gas concentration is not greater than a predetermined second determination concentration, the replacing amount of gas during this purge process is maintained. Thus, the time for this purge process can be shortened. Therefore, the fuel cell can start more quickly, whereby marketability of the fuel cell system is improved.

The control method of the present invention is a control method for controlling a fuel cell system provided with a fuel cell that supplies anode gas and cathode gas to an anode and a cathode, respectively, and generates electric power by a chemical reaction of the anode gas with the cathode gas, and a startup request detection means for detecting a startup request for the fuel cell, in which the control method includes: a scavenging process step of performing a scavenging process in which scavenging gas is supplied into an anode gas system in which anode gas and anode off gas circulate, when the fuel cell is stopped; and a startup-on-scavenging determination step of detecting a concentration of anode gas in the anode gas system as a first gas concentration, and determining whether to continue the scavenging process and prohibit the fuel cell from starting, or to suspend the scavenging process and allow the fuel cell to start, based on the detected first gas concentration, when a startup request for the fuel cell is detected while the scavenging process is performed.

In this case, it is preferable that, in the start-up-scavenging determination step, continuation of the scavenging process and prohibition of the fuel cell from starting are determined in a case where the detected first gas concentration is greater than a predetermined first determination concentration.

In this case, it is preferable that the fuel cell system further includes a dilution means for mixing anode off gas with dilution gas that dilutes the anode off gas, and discharging this gas mixed out of the fuel cell system. In addition, the control method further includes a startup purge control step of performing a purge process that replaces gas in the anode gas system with newly supplied anode gas when the fuel cell starts, in which, in the startup purge control step, in a case where the purge process is performed after the fuel cell is allowed to start in the startup-on-scavenging determination step, the concentration of anode off gas remaining in the dilution means is detected as a second gas concentration, and then the replacing amount of gas for the performing the purge process is decreased as the second gas concentration detected increases.

In this case, it is preferable that, in the startup purge control step, the replacing amount of gas for the purge process is maintained despite the detected second gas concentration in a case where the detected second gas concentration is not greater than a predetermined second determination concentration.

Each of these control methods expands the above-mentioned fuel cell system as an invention of a method, and achieves similar effects to the fuel cell system.

### BRIEF DESCRIPTION OF THE DRAWINGS

FIG. 1 is a block diagram illustrating a fuel cell system according to one embodiment of the present invention;

FIG. 2 is a time chart illustrating a specific example of the anode scavenging process control by the scavenging process execution unit according to the above-mentioned embodiment;

FIG. 3 is a flow chart illustrating the procedure of the startup purge process by the purge process execution unit according to the above-mentioned embodiment;

FIG. 4 is a time chart illustrating a specific example of the startup purge process when a startup request is detected in the “preliminary dry state” during the anode scavenging process according to the above-mentioned embodiment;

FIG. 5 is a time chart illustrating a specific example of the startup purge process control when a startup request is detected in the “dilution state” during the anode scavenging process according to the above-mentioned embodiment;

FIG. 6 is a time chart illustrating a specific example of the startup purge process when a startup request is detected in the “hydrogen discharge state” during the anode scavenging process according to the above-mentioned embodiment; and

FIG. 7 is a time chart illustrating a specific example of the startup purge process control according to a modification of the above-mentioned embodiment.

### DETAILED DESCRIPTION OF THE INVENTION

One embodiment of the present invention is described hereinafter with reference to the accompanying drawings.

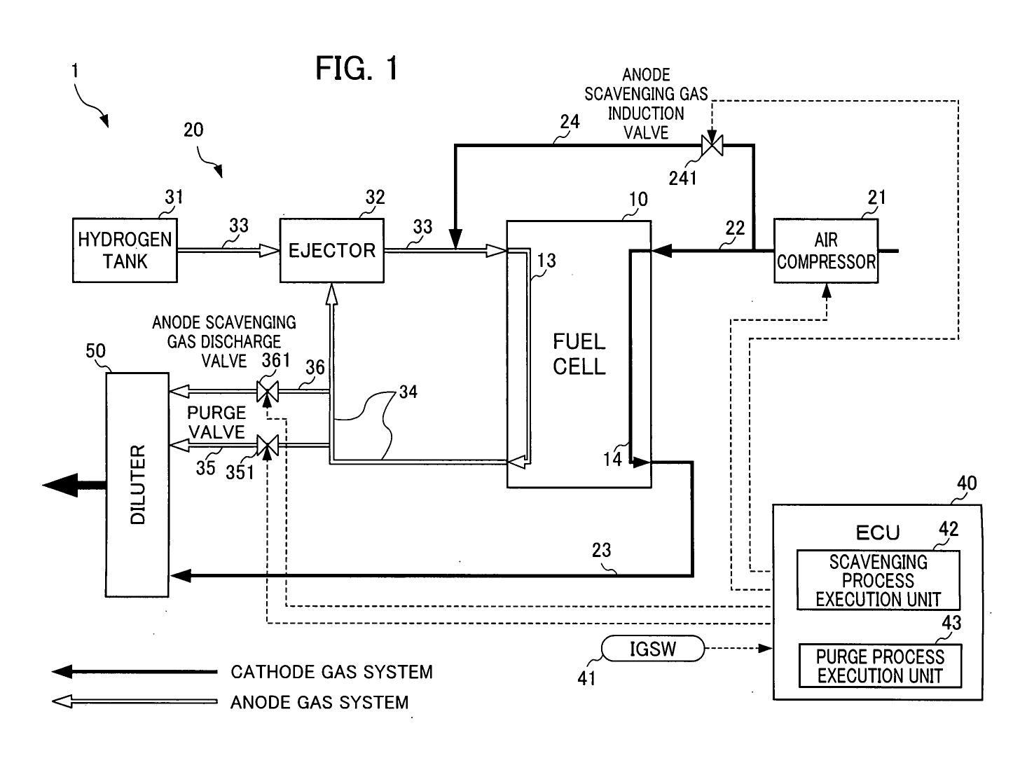

FIG. 1 is a schematic diagram of the fuel cell system 1 according to the present embodiment.

The fuel cell system 1 has a fuel cell 10, a supply device 20 supplying anode gas and cathode gas to this fuel cell 10, and an electronic control unit (hereinafter referred to as “ECU”) 40 that controls the fuel cell 10 and the supply device 20. This fuel cell system 1 is mounted on a fuel cell vehicle (not shown) that has electric power generated by the fuel cell 10 as a source of driving power.

The fuel cell 10 can be configured with a plurality, for example, tens or hundreds, of stacked cells. Each of the cells has a membrane electrode assembly (MEA) placed between a pair of separators. The MEA is configured with two electrodes which are an anode (negative electrode) and a cathode (positive electrode), and a solid polymer electrolyte membrane placed between these electrodes. Typically, both of the electrodes consist of a catalyst layer, which is in contact with the solid high-polymer electrolyte membrane on which an oxidation-reduction reaction occurs, and a gas diffusion layer in contact with this catalyst layer.

Supplying hydrogen gas as anode gas and air as cathode gas to the anode flow channel 13 formed at the anode side and the cathode flow channel 14 formed at the cathode side, respectively, causes the electrochemical reaction of these gases by which the fuel cell 10 produces electric power.

The supplying unit 20 is configured to include an air compressor 21 that supplies air to the cathode flow channel 14 of the fuel cell 10, and a hydrogen tank 31 and an ejector 32 that supply hydrogen gas to the anode flow channel 13 of the fuel cell 10.

The air compressor 21 connects with a first end side of the cathode flow channel 14 of the fuel cell 10 through an air supply channel 22. A second end side of the cathode flow channel 14 of the fuel cell 10 is connected with an air discharge channel 23, the top end side of which is connected with a diluter 50. The air discharge channel 23 is provided with a back pressure valve (not shown).

In addition, an anode scavenging gas induction channel 24 is provided to branch off of the air supply channel 22. The top end side of the anode scavenging gas induction channel 24 is connected with the below-mentioned hydrogen supply channel 33. Furthermore, this anode scavenging gas induction channel 24 is provided with an anode scavenging gas induction valve 241. While this anode scavenging gas induction valve 241 is in a closed state, the air supply channel 22 and the hydrogen supply channel 33 are blocked, and while the anode scavenging gas induction valve 241 is in an opened state, the air supply channel 22 is communicated with the hydrogen supply channel 33, so that air can be supplied to the hydrogen supply channel 33.

The hydrogen tank 31 is connected with a first end side of the anode flow channel 13 of the fuel cell 10 through the hydrogen supply channel 33. This hydrogen supply channel 33 is provided with an ejector 32. The hydrogen supply channel 33 between the hydrogen tank 31 and the ejector 32 is provided with an isolation valve and a regulator which reduces the pressure of hydrogen gas supplied from the hydrogen tank 31.

A second end side of the anode flow channel 13 of the fuel cell 10 is connected with a hydrogen reflux channel 34. The top end side of this hydrogen reflux channel 34 is connected with the ejector 32. The ejector 32 collects hydrogen gas circulating in the hydrogen reflux channel 34 to reflux the collected hydrogen gas to the hydrogen supply channel 33.

In addition, this hydrogen reflux channel 34 is provided with a hydrogen discharge channel 35 and an anode scavenging gas discharge channel 36 which branch off of this hydrogen reflux channel 34. The top end sides of the hydrogen discharge channel 35 and the anode scavenging gas discharge channel 36 are connected with the diluter 50.

The hydrogen discharge channel 35 is provided with a purge valve 351 that opens and closes this hydrogen discharge channel 35. When the below-mentioned purge process is performed, this purge valve 351 is opened to introduce gas circulating in the hydrogen reflux channel 34 to the diluter 50.

The anode scavenging gas discharge channel 36 is provided with an anode scavenging gas discharge valve 361 that opens and closes this anode scavenging gas discharge channel 36. When the below-mentioned scavenging process is performed, this anode scavenging gas discharge valve 361 is opened together with the purge valve 351 to introduce gas circulating in the hydrogen reflux channel 34 in the diluter 50.

The diluter 50, which uses cathode off gas introduced through the air discharge channel 23 as dilution gas, dilutes anode off gas introduced through the above-mentioned hydrogen discharge channel 35 and the above-mentioned anode scavenging gas discharge channel 36 by mixing the anode off gas with this dilution gas, and then discharges this gas mixed out of the fuel cell system 1.

In the present embodiment, the anode gas system, in which anode gas and anode off gas discharged from the fuel cell 10 circulate, consists of the anode flow channel 13, the hydrogen supply channel 33, the hydrogen reflux channel 34, the hydrogen discharge channel 35, and the anode scavenging gas discharge channel 36.

In addition, the cathode gas system, in which cathode gas and cathode off gas discharged from the fuel cell 10 circulate, consists of the cathode flow channel 14, the air supply channel 22, the air discharge channel 23, and the anode scavenging gas induction channel 24. In FIG. 1, the anode gas system is represented by the outlined arrows, and the cathode gas system is represented by the solid lined arrows.

The above-mentioned air compressor 21, the back pressure valve, the anode scavenging gas induction valve 241, the isolation valve, the purge valve 351, and the anode scavenging gas discharge valve 361, which are electrically connected with the ECU 40, are controlled by the ECU 40.

In addition, the ECU 40 is connected with an ignition switch 41 as a startup request detection means for detecting a startup request and a stop request for the fuel cell 10. This ignition switch 41 is provided near the driver's seat of a fuel cell vehicle equipped with the fuel cell system 1, and transmits an ON signal instructing the start of the fuel cell and an OFF signal instructing the stop of the fuel cell to the ECU 40 in response to the driver's operation. The ECU 40 starts and stops the fuel cell 10 in accordance with the ON/OFF signals output from the ignition switch 41.

The ECU 40 is provided with an input circuit having functions of shaping an input signal waveform from various sensors, correcting the voltage level into a predetermined level, and converting an analog signal value into a digital signal value; and a central processing unit (hereinafter referred to as “CPU”). In addition, the ECU 40 is provided with a memory circuit that stores various operation programs to be executed by the CPU and the operation result, and an output circuit outputting a control signal to the air compressor 21, the back pressure valve, the anode scavenging gas induction valve 241, the isolation valve, the purge valve 351, the anode scavenging gas discharge valve 361, and the like.

The ECU 40 is provided with a scavenging process execution unit 42 that performs the scavenging process, and a purge process execution unit 43 that performs the purge process. FIG. 1 shows a control block only for performing the scavenging process and the purge process. The scavenging process by the scavenging process execution unit 42 and the purge process by the purge process execution unit 43 are described below, respectively.

### Scavenging Process

The scavenging process is a process which purges the cathode gas system and anode gas system by supplying scavenging gas into the cathode gas system and the anode gas system. It should be noted that, in the present embodiment, air supplied from the air compressor 21 is used as scavenging gas. This scavenging process is performed during shutdown of the fuel cell 10, i.e. when the fuel cell is stopped. More specifically, there is a case where the scavenging process is performed immediately after the fuel cell 10 stops electric power generation, and a case in which the system is started every predetermined interval based on the RTC (Real Time Clock) built into the ECU 40 after the fuel cell 10 stops electric power generation, and the scavenging process is performed in response to requirements.

In addition, the scavenging process is configured to include the two processes: a cathode scavenging process in which the anode scavenging gas induction valve 241 is closed and only the cathode gas system is scavenged, and an anode scavenging process in which the anode scavenging gas induction valve 241 is opened and the anode gas system is scavenged.

The cathode scavenging process scavenges from the cathode gas system by driving the air compressor 21 with the anode scavenging gas induction valve 241 closed, and then maintaining the supply of scavenging gas in the cathode gas system for a predetermined time.

The objectives of the anode scavenging process are to replace gas containing hydrogen in the anode gas system with scavenging gas, to discharge water out of the anode gas system, and to dry the MEA of the fuel cell 10. Thus, this anode scavenging process scavenges from the anode gas system by opening the anode scavenging gas induction valve 241, driving the air compressor 21 with the anode scavenging gas discharge valve 361 and the purge valve 351 opened, and then maintaining the supply of scavenging gas in the anode gas system for a predetermined time.

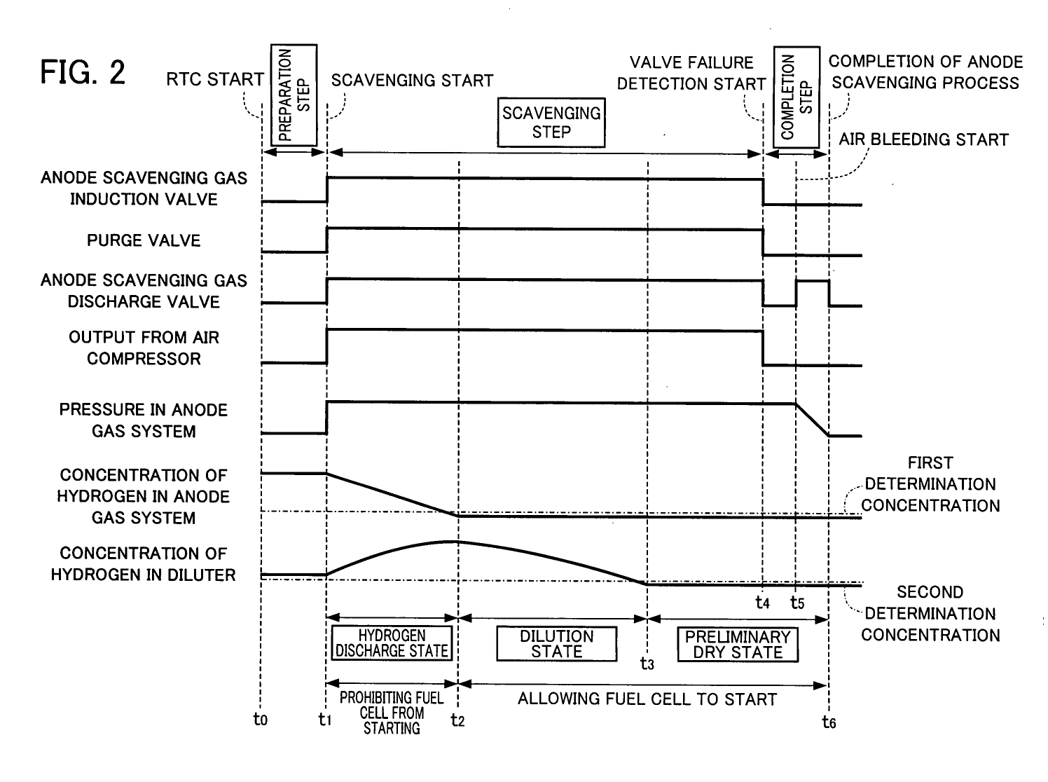

The anode scavenging process of the present embodiment is described below with reference to FIG. 2.

FIG. 2 is a time chart illustrating an example of anode scavenging process performed by the scavenging process execution unit of the ECU. FIG. 2 shows an example in which the scavenging process is started at a time t0 based on the RTC, and then completed at a time t6. In addition, the time chart shown in FIG. 2, from the upper row sequentially, shows the states of the anode scavenging gas induction valve, the purge valve, and the anode scavenging gas discharge valve, the output from the air compressor, the pressure in the anode gas system, the concentration of hydrogen in the anode gas system, and the concentration of hydrogen in the diluter.

As shown in FIG. 2, the anode scavenging process is configured to include the three steps: the “preparation step” (between the times t0 and t1), the “scavenging step” between the times t1 and t4), and the “completion step” (between the times t4 and t6).

In the “preparation step”, the preparation for driving the anode scavenging gas induction valve, the purge valve, the anode scavenging gas discharge valve, and the air compressor is conducted between the times t0 and t1 in order to scavenge from the anode gas system.

In the “scavenging step”, the anode gas system is scavenged by driving the air compressor with the anode scavenging gas induction valve, the purge valve, the anode scavenging gas discharge valve opened between the times t1 and t4. During this, the concentrations of hydrogen in the anode gas system and in the diluter gradually decrease. At the same time, water in the anode gas system is discharged, and the MEA of the fuel cell gradually dries.

In the “completion step”, failures in the valves are detected between the times t4 and t6. More specifically, between the times t4 and t5, all of the valves in relation to the anode gas system (the anode scavenging gas induction valve, the purge valve, and the anode scavenging gas discharge valve) are closed, and failures in these valves are determined by detecting a change in the pressure in the anode gas system. In other words, the pressure in the anode gas system decreases between the times t4 and t5 in a case where any of these three valves has a failure. Failures in the above-mentioned valves are detected by detecting a decrease in the pressure in the anode gas system, herein. Alternatively, if no failures are detected in the valves, only the anode scavenging gas discharge valve is opened between the times t5 and t6 to discharge air in the anode gas system (air bleeding), whereby the pressure in the anode gas system is decreased to ambient pressure, thereby completing the anode scavenging process.

Next, a state of the anode gas system and the diluter for the above-mentioned anode scavenging process is described below in detail.

Initially, between the times t1 and t2, gas containing hydrogen in the anode gas system is pushed out of the diluter together with water in the anode gas system by scavenging gas, whereby the inside of the anode gas system is replaced with the scavenging gas. Accordingly, the concentration of hydrogen in the anode gas system decreases between the times t1 and t2, and then the replacement of gas in the anode gas system is completed at the time t2. On the other hand, the concentration of hydrogen in the diluter increases between the times t1 and t2.

Next, hydrogen gas in the diluter is diluted by supplying scavenging gas to the diluter through the anode gas system between the times t2 and t3. In this way, the concentrations of hydrogen in the diluter decreases between the times t2 and t3.

Finally, the drying of the MEA of the fuel cell is promoted by maintaining the supply of scavenging gas after the hydrogen concentrations in the anode gas system and the diluter substantially decrease between times t3 and t4.

As mentioned above, the state of the fuel cell system during the anode scavenging process is separated in three, corresponding to the hydrogen concentration in the anode gas system, the hydrogen concentration in the diluter, and the state of the MEA.

In other words, the state of the fuel cell system is separated in three: the “hydrogen discharge state” (between the times t1 and t2) in which hydrogen and water in the anode gas system is discharged in the diluter, the “dilution state” (between the times t2 and t3) in which hydrogen in the diluter is diluted and then discharged out of the fuel cell system, and the “preliminary dry state” (between the times t3 and t6) in which the replacement in the anode gas system and the diluter is completed and the MEA is dry.

### Purge Process

Returning to FIG. 1, the purge process is a process which replaces gas circulating in the anode gas system with hydrogen gas newly supplied from the hydrogen tank 31 to increase the concentration of hydrogen in the anode gas system. More specifically, in this purge process, gas circulating in the anode gas system is replaced with newly supplied hydrogen gas by opening and closing the purge valve 351 at a predetermined timing, discharging gas circulating in the anode gas system out of the fuel cell system, and then newly supplying hydrogen from the hydrogen tank 31 to the anode gas system (hereafter, referred to as “purge-controlling”). In the present embodiment, the replacing amount of gas per unit time for performing this purge process, which is the amount of gas introduced to the diluter 50 per unit time, is defined as the purge amount. Therefore, this purge amount is approximately proportional to the opening period or the opening degree of the purge valve 351.

When this purge process is performed, gas containing hydrogen flows from the anode gas system to the diluter, so that the concentration of the anode off gas in the diluter increases temporarily. Therefore, it is preferable that the purge amount is set so that the concentration of hydrogen of the diluter during the purge process does not exceed the concentration dilutable by the diluter.

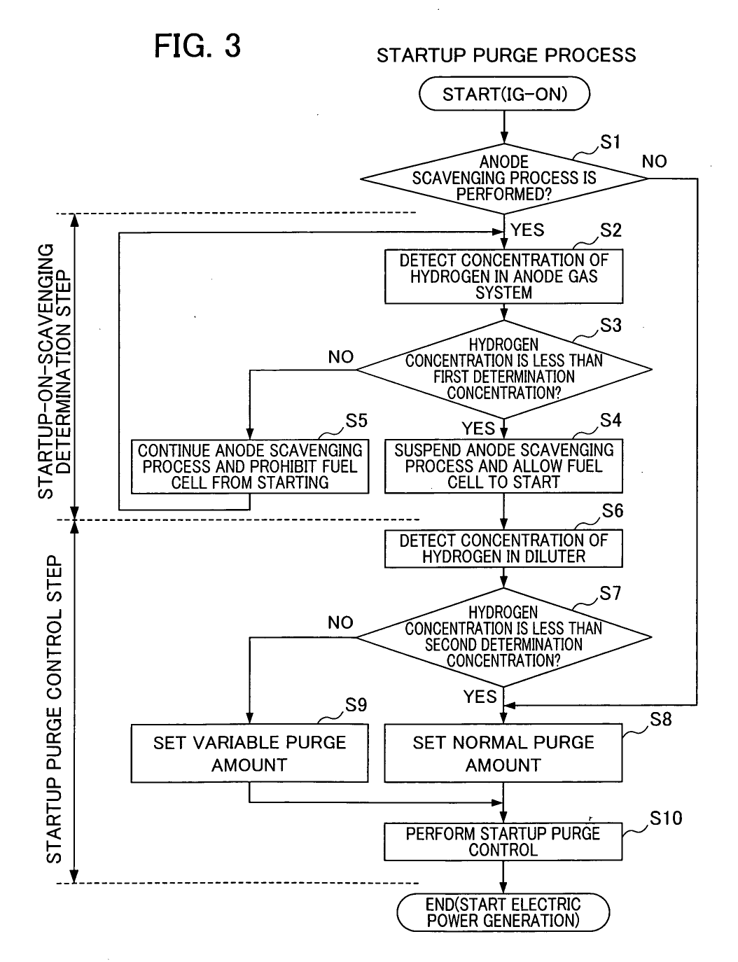

This purge process includes the startup purge process performed when the fuel cell 10 starts, so as to ensure the power generation performance of the fuel cell 10, and the intermittent purge process performed during electric power generation by the fuel cell 10 so as to maintain the power generation performance of the fuel cell 10. The startup purge process of the present embodiment is described below with reference to FIGS. 3 to 6.

FIG. 3 is a flow chart illustrating the procedure of the startup purge process by the purge process execution unit of the ECU.

This startup purge is performed when the ignition switch is turned on, i.e. when the ignition switch detects a startup request. As shown in FIG. 3, the startup purge process of the present embodiment includes the startup-on-scavenging determination step (Steps S2 to S5) of determining the startup of the fuel cell based on the concentration of hydrogen in the anode gas system, and the startup purge control step (Steps S6 to S10) of performing the startup purge control based on the concentration of hydrogen in the diluter.

In Step S1, it is determined whether or not the above-mentioned anode scavenging process is being performed. In a case in which the determination is “YES”, the process proceeds to Step S2, and in a case of “NO”, the process proceeds to Step S8.

In Step S2, the concentration of hydrogen in the anode gas system is detected, and then the process proceeds to Step S3. More specifically, in Step S2, the concentration of hydrogen in the anode gas system is detected based on the execution time of anode scavenging process, for example. In other words, the relationship between the execution time of anode scavenging process and the concentration of hydrogen in the anode gas system is set as a control map, and then the concentration of hydrogen in the anode gas system is detected based on this control map.

In Step S3, it is determined whether or not the detected concentration of hydrogen in the anode gas system is a predetermined first determination concentration or less. In a case where this determination is “YES”, the anode scavenging process is suspended, and the fuel cell is allowed to start (Step S4), because the concentration of hydrogen in the anode gas system is the first determination concentration or less, and then the process proceeds to Step S6. If this determination is “NO”, the anode scavenging process is continued, and the fuel cell is prohibited from starting (Step S5), because the concentration of hydrogen in the anode gas system is greater than the first determination concentration, and then the process proceeds to Step S2.

The above-mentioned first determination concentration is set in order to determine whether or not the fuel cell system can be allowed to start the fuel cell based on the concentration of hydrogen in the anode gas system. More specifically, this first determination concentration is set to a concentration when the “hydrogen discharge state” to the “dilution state” (refer to FIG. 2) among states of the fuel cell system during the above-mentioned anode scavenging process, for example.

When the first determination concentration is set as described above, in a case where the detected concentration of hydrogen in the anode gas system is greater than the first determination concentration, i.e. if the state of the fuel cell system is the “hydrogen discharge state”, it is determined that the discharge of hydrogen and water in the anode gas system has not completed in order to start the fuel cell, and then the anode scavenging process is continued and the fuel cell is prohibited from starting.

On the other hand, in a case where the detected concentration of hydrogen in the anode gas system is the first determination concentration or less, i.e. if the state of the fuel cell system is the “dilution state”, it is determined that the discharge of hydrogen and water in the anode gas system has completed in order to start the fuel cell, and then the anode scavenging process is suspended and the fuel cell is allowed to start.

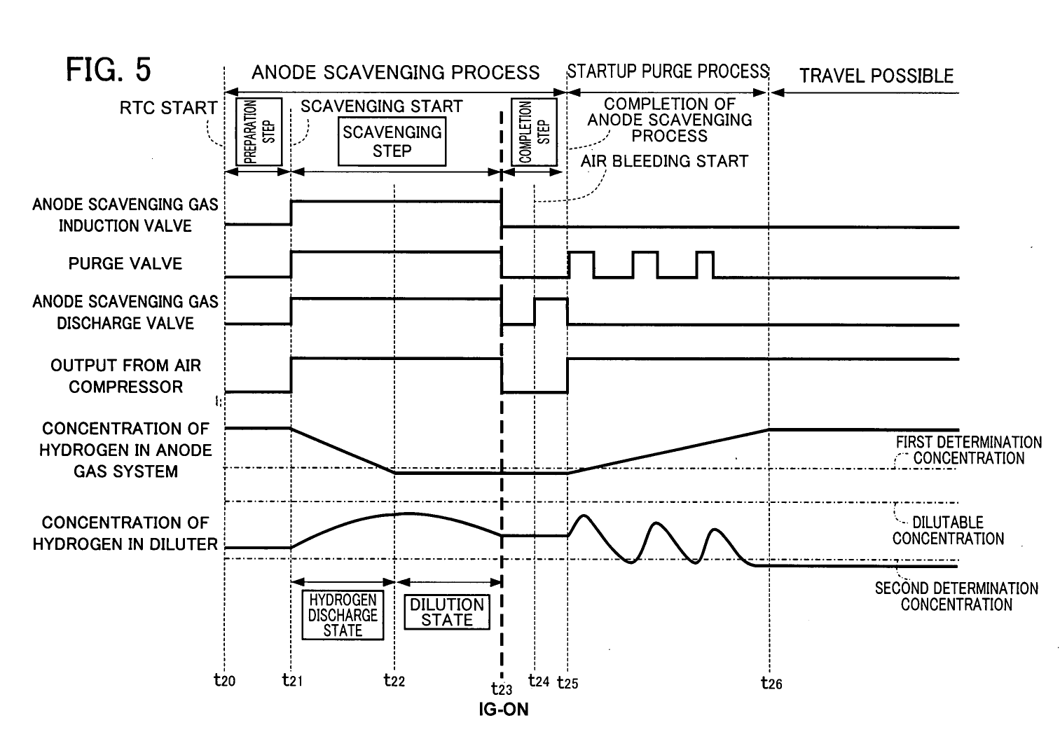

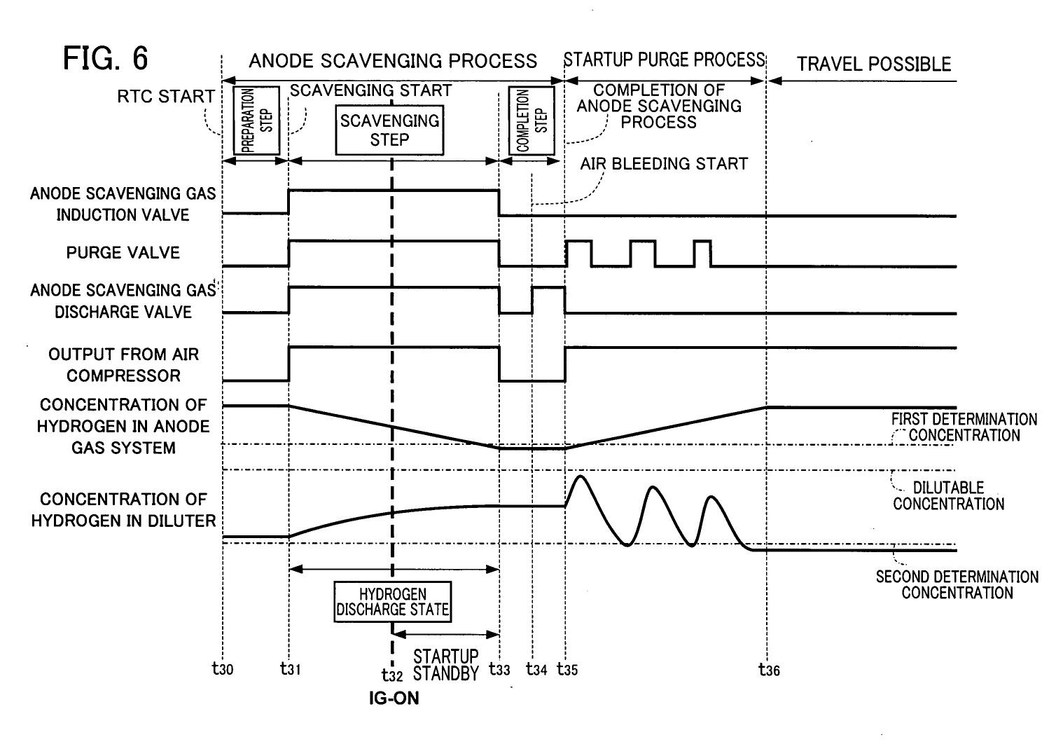

In addition, in a case where the anode scavenging process is suspended in Step S4, the “scavenging step” in the anode scavenging process is immediately suspended, and then the “completion step” is performed as described below in detail with reference to FIGS. 5 and 6.

In Step S6, the concentration of hydrogen in the diluter is detected, and then the process proceeds to Step S7. More specifically, in Step S6, the concentration of hydrogen in the diluter is detected based on the execution time of the anode scavenging process, for example. In other words, the relationship between the execution time of the anode scavenging process and the concentration of hydrogen in the diluter is set as a control map based on experiments, and then the concentration of hydrogen in the diluter is detected based on this control map.

In Step S7, it is determined whether or not the detected concentration of hydrogen in the diluter is a predetermined second determination concentration or less. In a case where this determination is “YES”, a predetermined normal purge amount (Step S8) is set as the purge amount corresponding to the performing of startup purge control because the concentration of hydrogen in the diluter is the second determination concentration or less, and then the process proceeds to the step S10. In addition, in a case where this determination is “NO”, a variable purge amount which is less than the above-mentioned normal purge amount (Step S9) is set as a purge amount corresponding to performing startup purge control because the concentration of hydrogen in the diluter is greater than the second determination concentration, and then the process proceeds to Step S10.

In Step S10, startup purge control is performed based on the set purge amount, and then the start purge process ends to start electric power generation by the fuel cell.

The above-mentioned normal purge amount is constantly set despite the detected concentration of hydrogen in the diluter. In addition, the variable purge amount is set to be less than the normal purge amount and decrease the purge amount as the detected concentration of hydrogen in the diluter increases, in order to prevent the discharge of a high concentration of gas from the diluter which is caused by performing the startup purge control.

At this point, the second determination concentration is set in order to determine whether or not the startup purge control can be performed at the normal purge amount based on the hydrogen concentration in the diluter. More specifically, this second determination concentration is set to the concentration when the state of the fuel cell system shifts the “dilution state” to the “preliminary dry state” (refer to FIG. 2) during the above-mentioned anode scavenging process, for example.

When the second determination concentration is set as described above, in a case where the detected concentration of hydrogen in the diluter is the second determination concentration or less, i.e. if the state of the fuel cell system is the “preliminary dry state”, it is determined that the concentration of hydrogen in the diluter is equivalent to or less than the concentration when the startup purge control can be performed at the normal purge amount, and then the startup purge control is performed at the normal purge amount.

Alternatively, in a case where the detected concentration of hydrogen in the diluter is greater than the second determination concentration, i.e. if the state of the fuel cell system is the “dilution state”, it is determined that the concentration of hydrogen in the diluter is greater than the concentration when the startup purge control can be performed at the normal purge amount, and then the startup purge control is performed at the variable purge amount, which is less than the normal purge amount. At this point, the purge amount is decreased as the concentration of hydrogen in the diluter increases.

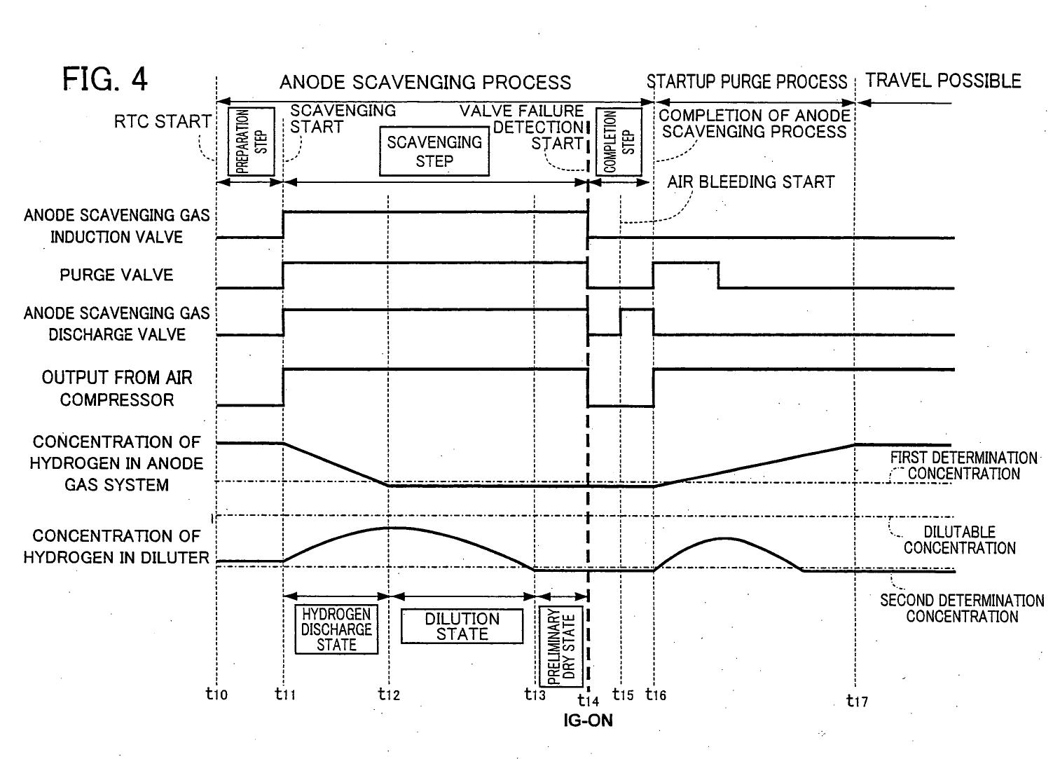

A specific example of the above-mentioned startup purge process is described below with reference to FIGS. 4 to 6. In addition, an example of control when a startup request is detected while the anode scavenging process is performed is described below.

FIG. 4 is a time chart illustrating a specific example of the startup purge process when a startup request is detected in the “preliminary dry state”. FIG. 4 shows an example in which the anode scavenging process is started at the time t10 based on the RTC, and then the startup request is detected at the time t14.

At the time t14, the concentration of hydrogen in the anode gas system is detected (refer to Step S2 of FIG. 3) and, in response to this hydrogen concentration being determined to be the first determination concentration or less (refer to Step S3 in FIG. 3), the “scavenging step” is suspended, the “completion step” is performed between the times t14 and t16, and then the anode scavenging process is suspended (refer to Step S4 in FIG. 3).

Next, at the time t16, the concentration of hydrogen in the diluter is detected (refer to Step S6 of FIG. 3) and, in response to this hydrogen concentration being determined to be the second determination concentration or less (refer to Step S7 in FIG. 3), the normal purge amount is set (refer to Step S8 in FIG. 3). Thereafter, the startup purge control is performed at the set normal purge amount (refer to the step S10 in FIG. 3), and then the startup purge process ends at the time t17. At this time, the fuel cell can generate electric power (the fuel cell vehicle can travel).

Here in particular, during the startup purge process (between the time t16 and t17), the concentration of hydrogen in the diluter increases temporarily by performing the startup purge control that opens the purge valve at the normal purge amount set. However, since the concentration of hydrogen in the diluter is substantially small in the “preliminary dry state”, the hydrogen concentration does not exceed the concentration dilutable by the diluter during the startup purge process.

FIG. 5 is a time chart illustrating a specific example of the startup purge process in a case where a startup request is detected in a “dilution state”. FIG. 5 shows an example in which the anode scavenging process is started at the time t20 based on the RTC, and then the startup request is detected at the time t23.

At the time t23, the concentration of hydrogen in the anode gas system is detected (refer to Step S2 of FIG. 3) and, in response to this hydrogen concentration being determined to be the first determination concentration or less (refer to Step S3 in FIG. 3), the “scavenging step” is suspended, the “completion step” is performed between the times t23 and t25, and then the anode scavenging process is suspended (refer to Step S4 in FIG. 3).

Next, at the time t25, the concentration of hydrogen in the diluter is detected (refer to Step S6 of FIG. 3) and, in response to this hydrogen concentration being determined to be greater than the second determination concentration (refer to Step S7 in FIG. 3), the variable purge amount is set in accordance with the concentration of hydrogen in the diluter (refer to Step S9 in FIG. 3). Thereafter, the startup purge control is performed at the set variable purge amount (refer to Step S10 in FIG. 3), and then the startup purge process ends at the time t26, whereby the fuel cell can generate electric power (the fuel cell vehicle can travel).

In the present embodiment, startup purge control is performed in accordance with the variable purge amount set by way of opening and closing the purge valve in a pulse mode, as shown in FIG. 5, and adjusting an open time of the purge valve per unit time.

In addition, during the startup purge process (between the time t25 and t26), the concentration of hydrogen in the diluter increases temporarily by performing the startup purge control. Furthermore, since the “scavenging step” of the anode scavenging process as described above is suspended, the concentration of hydrogen in the diluter is greater than the hydrogen concentration in the above-mentioned “preliminary dry state” (refer to FIG. 4). However, by performing the startup purge control at the variable purge amount set in accordance with the concentration of hydrogen in the diluter, the hydrogen concentration does not exceeded the concentration dilutable by the diluter during the startup purge process.

FIG. 6 is a time chart illustrating a specific example of the startup purge process when a startup request is detected in the “hydrogen discharge state”. FIG. 6 shows an example in which the scavenging process is started at the time t30 based on the RTC, and then the startup request is detected at the time t32.

At the time t32, the concentration of hydrogen in the anode gas system is detected (refer to Step S2 of FIG. 3) and, in response to this hydrogen concentration being determined to be greater than the first determination concentration (refer to Step S3 in FIG. 3), the fuel cell is prohibited from starting and the “scavenging step” of the anode scavenging process is continued. Accordingly, the concentration of hydrogen in the anode gas system decreases.

At the time t33, in response to this hydrogen concentration being determined to be the first determination concentration or less (refer to Step S3 in FIG. 3), the fuel cell is allowed to start, the “scavenging step” is suspended, the “completion step” is performed between the times t33 and t35, and then the anode scavenging process is suspended (refer to Step S4 in FIG. 3). Here, the fuel cell is a state of start standby in the interval from the detection of the startup request at the time t32 until startup of the fuel cell is allowed at time t33.

At the time t35, the concentration of hydrogen in the diluter is detected (refer to Step S6 of FIG. 3) and, in response to this hydrogen concentration being determined to be greater than the second determination concentration (refer to Step S7 in FIG. 3), the variable purge amount in accordance with the concentration of hydrogen in the diluter is set (refer to Step S9 in FIG. 3). Thereafter, the startup purge control is performed at the set variable purge amount (refer to Step S10 in FIG. 3), and then the startup purge process ends at the time t36, whereby the fuel cell can generate electric power (the fuel cell vehicle can travel).

In the present embodiment, startup purge control is performed in accordance with the variable purge amount set by way of opening and closing the purge valve in a pulse mode, as shown in FIG. 6, and adjusting an open time of the purge valve per unit time.

In addition, during the startup purge process (between the time t35 and t36), the concentration of hydrogen in the diluter increases temporarily by performing the startup purge control. Furthermore, since the “scavenging step” of the anode scavenging process as mentioned above is suspended, the concentration of hydrogen in the diluter is greater than the hydrogen concentration in the above-mentioned “preliminary dry state” (refer to FIG. 4). However, the startup purge control is performed at the variable purge amount set in accordance with the concentration of hydrogen in the diluter, so that the hydrogen concentration does not exceeded the concentration dilutable by the diluter during the startup purge process.

The present embodiment has the following advantages.

(1) In a case where a startup request for the fuel cell 10 is detected while the anode scavenging process is being performed, the concentration of hydrogen in the anode gas is detected, and then, based on this hydrogen concentration, it is determined whether to continue the anode scavenging process and prohibit the fuel cell 10 from starting, or to suspend the anode scavenging process and allow the fuel cell 10 to start. Accordingly, when a startup request is detected while the anode scavenging process is performed, the fuel cell 10 may be able to start quickly without waiting until this anode scavenging process has completed. Here in particular, it is determined whether to allow the fuel cell 10 to start or to prohibit the fuel cell from starting in response to the concentration of hydrogen in the anode gas system. In this way, stable power generation of the fuel cell 10 can be ensured after startup, and can start more quickly, thereby improving marketability of the fuel cell system 1.

(2) When a startup request for the fuel cell 10 is detected while the anode scavenging process of the anode gas system is being performed, the concentration of hydrogen in the anode gas system is detected and, in a case where the hydrogen concentration is greater than a predetermined first determination concentration, the anode scavenging process is continued, and starting of the fuel cell 10 is prohibited. Therefore, the fuel cell 10 is prevented from being allowed to start in a state where the anode scavenging process has not been substantially completed, thereby improving the marketability of the fuel cell system 1.

(3) In a case where the startup purge process is performed after startup of the fuel cell 10 is allowed, the concentration of hydrogen in the diluter 50 is detected, and then the purge amount for the startup purge process decreases as this hydrogen concentration increases. Thus, the startup purge process is performed in accordance with the concentration of hydrogen remaining in the diluter 50, so that the time for this startup purge process can be shortened. Therefore, the fuel cell 10 can start more quickly, whereby marketability of the fuel cell system 1 can be improved.

(4) When the startup purge process is performed after the fuel cell 10 has been allowed to start, the concentration of hydrogen in the diluter 50 is detected and, in a case where this hydrogen concentration is not greater than a predetermined second determination concentration or less, the replacing amount of gas for the startup purge process is maintained. In this way, the time for the startup purge process can be shortened. Therefore, the fuel cell 10 can start more quickly, whereby the marketability of the fuel cell system 1 can be improved.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

In the above-mentioned embodiment, the first gas concentration detection means indirectly detects the concentration of hydrogen in the anode gas system based on the execution time of the anode scavenging process in Step S2 of FIG. 2, but is not limited thereto. For example, a hydrogen sensor may be provided in the anode gas system, whereby the concentration of hydrogen in the anode gas system is directly detected. Alternatively, the pressure in the anode gas system may be indirectly detected based on the pressure in the anode gas system.

In addition, in the above-mentioned embodiment, the second gas concentration detection means indirectly detects the concentration of hydrogen in the diluter based on the execution time of the anode scavenging process in Step S6 of FIG. 2, but is not limited thereto. For example, a hydrogen sensor may be provided in the diluter, whereby the concentration of hydrogen in the diluter is directly detected. Alternatively, the concentration of hydrogen in the diluter may be indirectly detected based on the pressure in the diluter.

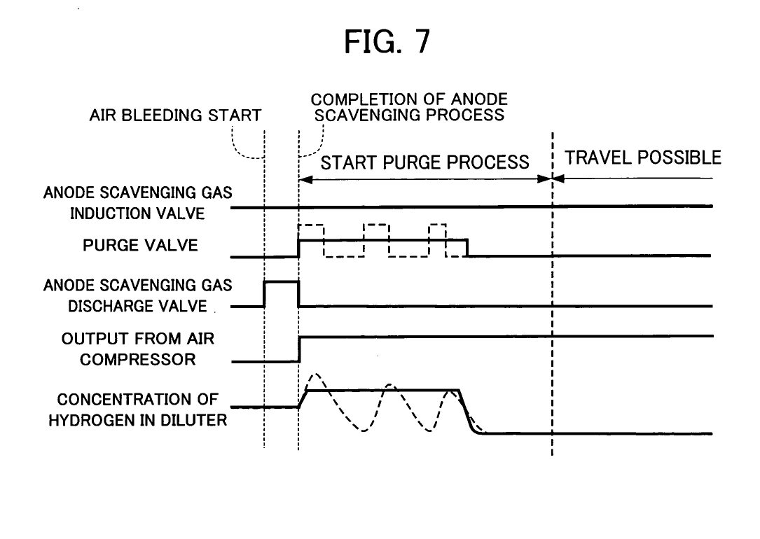

Furthermore, in the above-mentioned embodiment, startup purge control is performed in according with a variable purge amount set by way of adjusting an open time of the purge valve per unit time and opening and closing the purge valve in pulse mode, but is not limited thereto. For example, the startup purge control may be performed in accordance with the variable purge amount set by adjusting the opening degree of the purge valve, as shown in FIG. 7. It should be noted that, in FIG. 7, an example of control by the above-mentioned embodiment in which the open time of the purge valve is adjusted is represented by the dashed line, and an example of control by the variation in which the degree of opening of the purge valve is adjusted is represented by the continuous line.

What is claimed is:

1. A fuel cell system comprising: a fuel cell that supplies anode gas and cathode gas to an anode and a cathode, respectively, and generates electric power by a reaction of the anode gas with the cathode gas;
a scavenging means for performing a scavenging process in which scavenging gas is supplied into an anode gas system in which anode gas and anode off gas circulate, when the fuel cell is stopped;
a startup request detection means for detecting a startup request for the fuel cell;
a first gas concentration detection means for detecting a concentration of anode gas in the anode gas system as a first gas concentration; and
a startup-on-scavenging determination means for determining whether to continue the scavenging process and prohibit the fuel cell from starting, or to suspend the scavenging process and allow the fuel cell to start, based on the detected first gas concentration, when a startup request for the fuel cell is detected while the scavenging process is performed.

2. The fuel cell system according to claim 1, wherein the startup-on-scavenging determination means determines that the scavenging process is continued to prohibit the fuel cell from starting in a case where the detected first gas concentration is greater than a predetermined first determination concentration.

3. The fuel cell system according to claim 2, further comprising a dilution means for mixing anode off gas with dilution gas diluting the anode off gas, and then discharging the gas mixed out of the fuel cell system,
a second gas concentration detection means for detecting a concentration of anode off gas remaining in the dilution means as a second gas concentration; and
a startup purge means for performing a purge process in which gas in the anode gas system is replaced with newly supplied anode gas when the fuel cell starts, wherein
the startup purge means decreases the replacing amount of gas for the purge process as the detected second gas concentration increases, when the purge process is performed after the startup-on-scavenging determination means allows the fuel cell to start.

4. The fuel cell system according to claim 3, wherein the startup purge means maintains the replacing amount of gas for the purge process despite the detected second gas concentration in a case where the detected second gas concentration is not greater than a predetermined second determination concentration.

5. The fuel cell system according to claim 1, further comprising a dilution means for mixing anode off gas with dilution gas diluting the anode off gas, and then discharging the gas mixed out of the fuel cell system,
a second gas concentration detection means for detecting a concentration of anode off gas remaining in the dilution means as a second gas concentration; and
a startup purge means for performing a purge process in which gas in the anode gas system is replaced with newly supplied anode gas when the fuel cell starts, wherein
the startup purge means decreases the replacing amount of gas for the purge process as the detected second gas concentration increases, when the purge process is performed after the startup-on-scavenging determination means allows the fuel cell to start.

6. The fuel cell system according to claim 5, wherein the startup purge means maintains the replacing amount of gas for the purge process despite the detected second gas concentration in a case where the detected second gas concentration is not greater than a predetermined second determination concentration.

7. A control method for controlling a fuel cell system, which includes a fuel cell that supplies anode gas and cathode gas to an anode and a cathode, respectively, and generates electric power by reacting the anode gas with the cathode gas, and
a startup request detection means for detecting a startup request for the fuel cell, the control method comprising:
a scavenging process step of performing a scavenging process in which scavenging gas is supplied into an anode gas system in which anode gas and anode off gas circulate, when the fuel cell is stopped; and
a startup-on-scavenging determination step of detecting a concentration of anode gas in the anode gas system as a first gas concentration, and determining whether to continue the scavenging process and prohibit the fuel cell from starting, or to suspend the scavenging process and allow the fuel cell to start, based on the detected first gas concentration, when a startup request for the fuel cell is detected while the scavenging process is performed.

8. The control method for controlling the fuel cell system according to claim 7, wherein, in the startup-on-scavenging determination step, continuation of the scavenging process and prohibition of the fuel cell from starting are determined in a case where the detected first gas concentration is greater than a predetermined first determination concentration.

9. The control method for controlling the fuel cell system according to claim 8, the fuel cell system further includes a dilution means for mixing anode off gas with dilution gas, which dilutes the anode off gas, and then discharges the gas mixed out of the fuel cell system, the control method further comprising:
a startup purge control step of performing a purge process in which gas in the anode gas system is replaced with newly supplied anode gas when the fuel cell starts, wherein
in the startup purge control step, the concentration of anode off gas remaining in the dilution means is detected as a second gas concentration, and then the replacing amount of gas for the purge process is decreased as the detected second gas concentration increases, in a case where the purge process is performed after the fuel cell is allowed to start in the startup-on-scavenging determination step.

10. The control method for controlling the fuel cell system according to claim 9, wherein in the startup purge control step, the replacing amount of gas for the purge process is maintained despite the detected second gas concentration in a case where the detected second gas concentration is not greater than a predetermined second determination concentration.

11. The control method for controlling the fuel cell system according to claim 7, the fuel cell system further includes a dilution means for mixing anode off gas with dilution gas, which dilutes the anode off gas, and then discharges the gas mixed out of the fuel cell system, the control method further comprising:
a startup purge control step of performing a purge process in which gas in the anode gas system is replaced with newly supplied anode gas when the fuel cell starts, wherein
in the startup purge control step, the concentration of anode off gas remaining in the dilution means is detected as a second gas concentration, and then the replacing amount of gas for the purge process is decreased as the detected second gas concentration increases, in a case where the purge process is performed after the fuel cell is allowed to start in the startup-on-scavenging determination step.

12. The control method for controlling the fuel cell system according to claim 11, wherein in the startup purge control step, the replacing amount of gas for the purge process is maintained despite the detected second gas concentration in a case where the detected second gas concentration is not greater than a predetermined second determination concentration.
